(19) United States
(12) Patent Application Publication
(10) Pub. No.: US 2009/0091620 A1
(43) Pub. Date: Apr. 9, 2009

(54) ELECTRONIC SECURITY SYSTEM

(76) Inventor: LEROY E. ANDERSON, BOISE, ID (US)

Correspondence Address: DYKAS, SHAVER & NIPPER, LLP, P.O. BOX 877, BOISE, ID, 83701-0877, US

(21) Appl. No.: 12/246,304

(22) Filed: Oct. 6, 2008

Related U.S. Application Data
(60) Provisional application No. 60/977,790, filed on Oct. 5, 2007.

(51) Int. Cl. H04N 7/18; H04N 5/232

(52) U.S. Cl. 348/159; 348/347; 348/E07.085; 348/E05.042

(57) ABSTRACT

The invention is an electronic security system for placement in a building so that a person may view, on an electronic screen, an image from one of several digital cameras placed around the building. The unit includes a zoom function which zooms to the lower center, to the right, left, lower left, or lower right of the screen in order to give the user inside the door a better view of a person or persons viewed in a digital camera inside or outside the building.

### CROSS-REFERENCE TO RELATED APPLICATIONS

This application claims the priority date of the provisional application entitled ELECTRONIC SECURITY SYSTEM filed by Leroy E. Anderson on Oct. 5, 2007 with application Ser. No. 60/977,790.

### FIELD OF THE INVENTION

The invention generally relates to an apparatus for viewing digital cameras in a security system and more particularly to a digital device for using an off center zoom for viewing images form a digital security camera.

### BACKGROUND OF THE INVENTION

There are a number of digital security systems available today. A feature that none of them possess is having a portable viewing screen for monitoring the views from the cameras of the system. Another feature that is needed is the function in the viewer of zooming in to a region other than the center of the image. It is known to zoom to the center of an image, but existing systems do not have the ability to zoom to a point that is not in the center of the image. This could be a very beneficial feature to enhance a viewer's ability to monitor a region covered by a camera.

### SUMMARY OF THE INVENTION

The invention is an electronic security system which includes a plurality of digital camera lens units, a digital viewing screen unit, a zoom feature, a zoom activation button. The digital camera lens units are configured for mounting into a position adjacent to a region to be viewed, with the region to be viewed located at some distance remote from the user of the electronic security system. The digital viewing screen unit is configured for mounting in a convenient location inside the building, or may be a portable unit which may be carried by the user to different locations within the building. Each of the digital camera lenses is electrically connected to the digital camera lens by wireless or conventional wired means. The digital viewing screen is positioned, whether in a pre-existing hole or by one drilled for this purpose, in a convenient position for the user of the electronic security system to view an image on the digital viewing screen of what is outside the door.

The digital view screen unit includes a zoom feature that selects a region in the displayed image for magnification with that region being a region other than the center of the image. The typical zoom lens zooms towards the center of the image and makes the center of an image larger. The zoom feature of this viewer zooms to a region that is not the center of the picture, and that, in one version, can be selectable by the user. For instance, the viewer may be configured to zoom to the lower center of the image. This kind of a zoom would be useful if the person in the image is not centered in the image, but the viewer wants to get a better look at the person. If the person being viewed is standing to the left or right of the center of the door, or if they are crouched lower than the typical field of view of a door viewer, a viewer with such a feature would be beneficial and would allow zooming in without have the camera itself moving to center the part of the image to be magnified. Zooming to the center bottom of the image, in such a case, would allow the user viewing the system to get a better image of a person to the side, top, or bottom of the image.

A zoom activation button is included that can take a number of different forms which will be discussed below. An image which is viewed in the digital viewing screen is magnified when the zoom activation button is activated and the image is magnified to show greater detail in that part of the image which is selected.

In one embodiment, the device is configured specifically to zoom in on the lower center of the displayed image. The zoom feature can be based on optics in the digital camera lens and also can be based on software enhancement of the image by digital manipulation. The zoom feature can also be specifically configured to zoom in on the lower right region of the image or the lower left region of the image. The device can also be configured with the capacity to zoom in on more than one region of the image, with the selection of the region for zooming in being left to the user's control. In such a case, a zone selection button would be provided, which would allow the region of the image selected for magnification to be identified by the user. The zone selection button can be in the form of a touch screen button, such as allowing the user to merely touch the lower center, lower right, lower left, upper center, upper right, or upper left at his discretion, with the resulting magnification of that region of the image. The zone selection button can also take the form of a button which is activated repeatedly, and the selection area cycled through the different options of regions for magnification until the user selects which view he would like to have magnified.

The electronic security system can also have a magnification button with which the user selects from a number of different levels of magnification. The electronic security system can also have a brightness button to allow the user to adjust the brightness of the image to a preferred level of brightness.

For night or better vision, LED lights can be added and directed to various areas that can be activated when motion is detected by a camera of the system.

The electronic security system can be used in multiples, such as with a number of digital camera lenses placed at various locations around a house, with all of them viewable on one or more digital viewing screen(s). A camera selection button would be provided in this instance to provide a way for the user to select the image and camera that are to be displayed on the monitor. This version of the electronic security system would have a selection means to select a region on each image of each camera for viewing and magnification of the selected region. A magnification selection means would be provided for different levels of magnification for any of the images for any of the cameras of this version of the device. When used in security applications, a motion detector could be used to turn the camera(s) on, or a switch on the monitor or a combination of both. A memory program may be added to the cameras so an individual may come later and play back what the camera has seen, with magnification available for the views recorded. A speaker and a microphone can be added to the camera unit so a person can carry on a conversation between the monitor and the camera unit so that somebody in the house can control a gate like a sentry unit. The camera could be used with a motion sensor so motion would also activate an alarm in the home and the monitor.

The electronic security system of the invention can be configured to operate with battery power or ac power, with rechargeable batteries, DC, or any combination of those electrical sources.

The purpose of the foregoing Abstract is to enable the public, and especially the scientists, engineers, and practitioners in the art who are not familiar with patent or legal terms or phraseology, to determine quickly from a cursory inspection, the nature and essence of the technical disclosure of the application. The Abstract is neither intended to define the invention of the application, which is measured by the claims, nor is it intended to be limiting as to the scope of the invention in any way.

Still other features and advantages of the present invention will become readily apparent to those skilled in this art from the following detailed description describing preferred embodiments of the invention, simply by way of illustration of the best mode contemplated by carrying out my invention. As will be realized, the invention is capable of modification in various obvious respects all without departing from the invention. Accordingly, the drawings and description of the preferred embodiments are to be regarded as illustrative in nature, and not as restrictive in nature.

### BRIEF DESCRIPTION OF THE DRAWINGS

FIG. 1 is a perspective view of the security system of the invention.

FIG. 2 is a front view of the viewer with an image on the screen.

FIG. 3 is a front view of the viewer zoomed in on an image in lower center.

### DESCRIPTION OF THE PREFERRED EMBODIMENTS

While the invention is susceptible of various modifications and alternative constructions, certain illustrated embodiments thereof have been shown in the drawings and will be described below in detail. It should be understood, however, that there is no intention to limit the invention to the specific form disclosed, but, on the contrary, the invention is to cover all modifications, alternative constructions, and equivalents falling within the spirit and scope of the invention as defined in the claims.

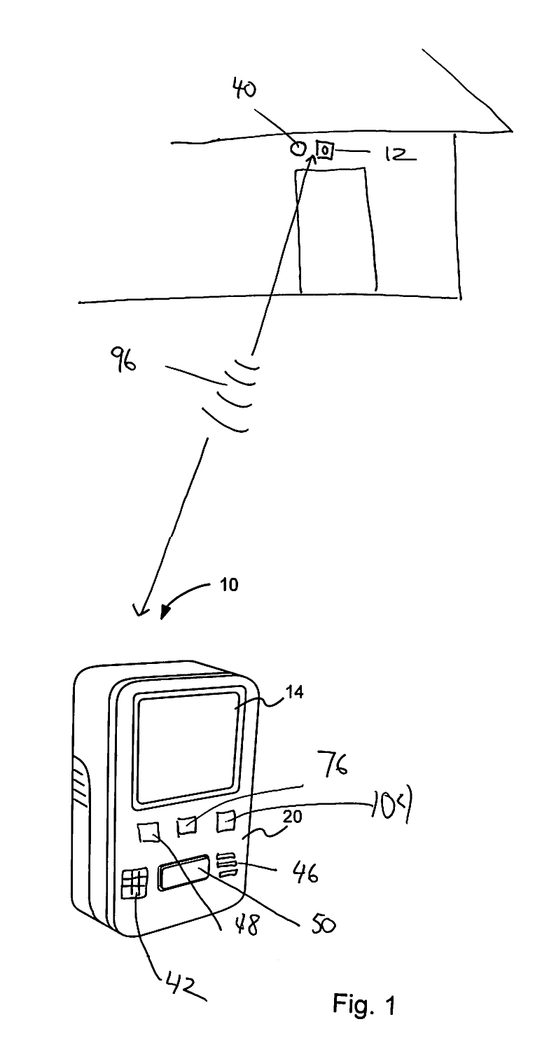

The electronic security system of the invention is shown in FIGS. 1-3. FIG. 1 shows a perspective view of the system 10 of the invention. Shown is the viewer body 20 with the digital viewing screen 14. Attached to a building exterior is one of the digital camera lens units 12, sending a wireless signal to the digital viewer 12.

The electronic security system 10 of the invention further includes a speaker/microphone 46, a zoom point selection pad 42, a brightness button 48, a magnification button 50, a camera selection button, a light switch 104,

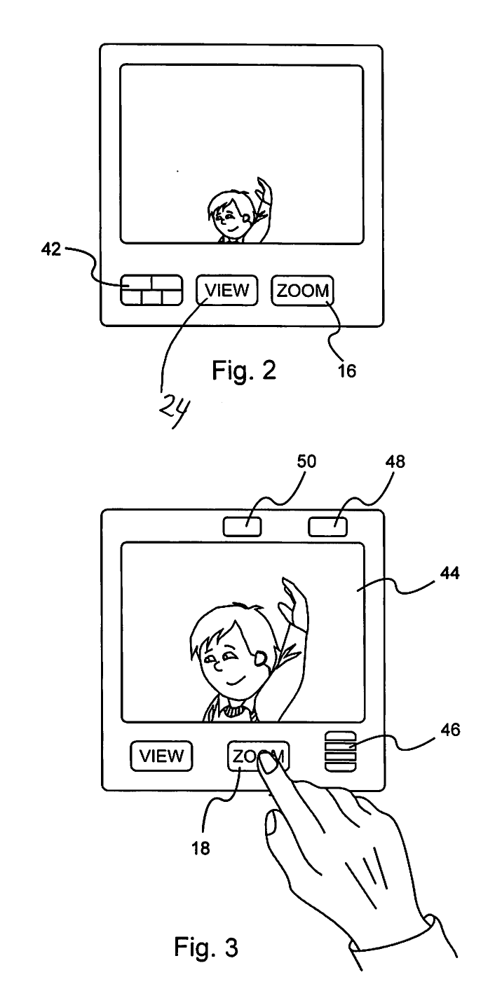

The electronic security system 10 of the invention also has the capability of zooming in on an object with a zoom feature which zooms to an off-center region of the screen. It is common in the prior art for an electronic viewing device to zoom straight forward and to magnify the portion of the screen which is in the center of the screen. This is generally a workable practice in Items such as cameras. However, in a viewer which is utilized in a door situation, it is more advantageous to zoom to an area that is not in the center of the view screen. This requires the use of a zoom point selection pad which can be in the form of a pad of buttons shown in FIG. 2, or can be in the form of a touch screen zoom selection such as shown in FIG. 3. By choosing the area to zoom towards, the view screen zooms, for instance, to the lower bottom of the screen, the lower left or right, the right side of the screen, the left side of the screen, or the center left or right upper part of the screen.

FIG. 2 shows an image of a person in the lower center of the view screen 14. When a selection is made on the zoom point selection pad 42 to zoom to the lower center of the screen, the view changes to that shown in FIG. 3. Shown in FIG. 3 is a view button 24 which activates the unit and a zoom button 16 which controls the amount of magnification of the image.

FIG. 3 also shows a magnification button 50, and a brightness button 48. The brightness button 48 can be tapped to brighten the image on the view screen.

While there is shown and described the present preferred embodiment of the invention, it is to be distinctly understood that this invention is not limited thereto but may be variously embodied to practice within the scope of the following claims. From the foregoing description, it will be apparent that various changes may be made without departing from the spirit and scope of the invention as defined by the following claims.

I claim:

1. An electronic security system, comprising:
a plurality of digital camera lens units for mounting in a position adjacent to a region to be viewed, with said region to be viewed remote from a user of said electronic security system;
at least one digital viewing screen unit for mounting in a position at a selected distance from said plurality of digital camera lens units, for convenient viewing of one or more images from said camera units;
a zoom feature in which a selected region of said selected image is magnified, in which the region magnified is a region other than the center of the image of said region to be viewed;
a zoom activation button; wherein
an image viewed in said digital viewing screen unit is magnified when said zoom activation button, and said image is magnified to show greater detail of a part of the image which is not the center of the image.

2. The electronic security system of claim 1 in which said zoom feature is configured to magnify a region of said image located in the lower center of said image.

3. The electronic security system of claim 1 in which said zoom feature is based on software magnification of said image.

4. The electronic security system of claim 1 in which said zoom feature is configured to magnify a region of said image located in the lower right of said image.

5. The electronic security system of claim 1 in which said zoom feature is configured to magnify a region of said image located in the lower left of said image.

6. The electronic security system of claim 1 in which said zoom feature is configured to magnify one of a plurality of regions of said image, in which the region to be magnified is not the center of the image.

7. The electronic security system of claim 6 in which said electronic security system further comprises a zone selection button, for selecting a region of said image to magnify.

8. The electronic security system of claim 6 in which said electronic security system further comprises a zone selection button in the form of a touch screen, for selecting a region of said image to magnify.

9. The electronic security system of claim 1 in which digital camera lens' said zoom feature is configured to magnify one of a plurality of regions of said image, in which the region to be magnified is not the center of the image.

10. The electronic security system of claim 7 which further comprises a magnification button to change magnification to different levels of magnification.

11. The electronic security system of claim 7 which further comprises a brightness button to change brightness of said image to different levels of brightness.

13. The electronic security system of claim 1 in which said digital camera lens units are configured for mounting at selected viewpoints of a building for monitoring movement in a selected zone.

14. The electronic security system of claim 1 which further includes a voice transmittal feature.

16. The electronic security system of claim 1 which further includes at least one light source associated with said plurality of digital camera lens units, for illuminating a region viewed by said digital camera units.

17. The electronic security system of claim 1 in which said digital viewing screen is configured to be portable from said digital camera lens, for placement in any location chosen by a user.

18. The electronic security system of claim 1 which further comprises a selection means to select a region on each image of each camera for viewing, and a magnification means for magnification of the selected region of the selected image.

19. The electronic security system of claim 18 which further comprises a magnification selection means for selecting different levels of magnification for the image selected from the various cameras.

20. The electronic security system of claim 18, which further includes an alarm configured to sound when movement is detected in a region viewed by a particular camera unit.
